(19) United States
(12) Patent Application Publication
(10) Pub. No.: US 2013/0279537 A1
(43) Pub. Date: Oct. 24, 2013

(54) DISPLAY PANEL TEMPERATURE SENSING APPARATUS

(71) Applicant: NOVATEK MICROELECTRONICS CORP., HsinChu (TW)

(72) Inventor: Wing-Kai TANG, Hsinchu City (TW)

(21) Appl. No.: 13/866,776

(22) Filed: Apr. 19, 2013

(30) Foreign Application Priority Data
Apr. 20, 2012 (TW) 101114236

(51) Int. Cl. G01K 13/00

(52) U.S. Cl. CPC G01K 13/00
USPC 374/141

(57) ABSTRACT

A display panel temperature sensing apparatus, in an embodiment, includes a display panel, at least one temperature-sensing component, at least one passive device, and an oscillation circuit. The at least one temperature-sensing component is disposed on the display panel. The at least one passive device is coupled to the at least one temperature-sensing component to form a resistance-capacitance (RC) structure. The oscillation circuit is coupled to the RC structure and an output terminal of the oscillation circuit outputs a temperature-sensing signal.

This application claims the benefit of Taiwan application Serial No. 101114236, filed Apr. 20, 2012, the subject matter of which is incorporated herein by reference.

### BACKGROUND OF THE INVENTION

1. Field of the Invention

The invention relates in general to a display panel temperature sensing apparatus.

2. Description of the Related Art

For a display panel, such as a liquid crystal display panel, the display quality has much to do with temperature. If the temperature of a display panel can be obtained, then display parameters can be compensated and adjusted to maintain the display quality according to the temperature.

The working state of liquid crystal is affected by the change in temperature. Temperature affects the liquid crystal's threshold voltage and directly affects the contrast of the display. The rise in temperature will decrease the threshold voltage, making the non-display state approaching the display state gradually. Therefore, the ambient temperature is a factor that needs to be considered for application of components of the liquid crystal display. If the ambient temperature changes significantly, then bias voltage needs to be adjusted along with the change in temperature to make the driving voltage adapted to the change in the threshold voltage. Therefore, display quality can be improved by adding a temperature compensating mechanism to a liquid crystal module within a particular temperature range.

### SUMMARY OF THE INVENTION

The invention is directed to a display panel temperature sensing apparatus. In some embodiments, the display panel temperature sensing apparatus may output a temperature-sensing signal with a circuit having lower complexity and the functions of the circuit are extendable. Some embodiments facilitate subsequent temperature-related processing, such as temperature compensating adjustment of display quality.

According to one embodiment of the present invention, a display panel temperature sensing apparatus including a display panel, at least one temperature-sensing component, at least one passive device and an oscillation circuit is provided. The at least one temperature-sensing component is disposed on the display panel. The at least one passive device is coupled to the at least one temperature-sensing component to form a resistance-capacitance (RC) structure. The oscillation circuit is coupled to the RC structure, and an output terminal of the oscillation circuit outputs a temperature-sensing signal.

According to another embodiment of the present invention, a display panel temperature sensing apparatus including a display panel, a plurality of temperature-sensing components and an oscillation circuit is provided. These temperature-sensing components are disposed on the display panel to form an RC structure. These temperature-sensing components include at least one resistive temperature-sensing component and at least one capacitive temperature-sensing component. The oscillation circuit is coupled to the RC structure, and an output terminal of the oscillation circuit outputs a temperature-sensing signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a block diagram of a display panel temperature sensing apparatus according to an embodiment.

FIG. 2 shows a block diagram of a display panel temperature sensing apparatus according to another embodiment.

FIG. 3 shows a block diagram of an RC oscillation circuit of a display panel temperature sensing apparatus according to an embodiment.

FIG. 4 shows a wave diagram of the output characteristics of an RC oscillation circuit of FIG. 3.

FIG. 5 shows a block diagram of an RC oscillation circuit of a display panel temperature sensing apparatus according to another embodiment.

FIG. 6 shows a block diagram of a display panel temperature sensing apparatus according to another embodiment.

FIG. 7 (Prior Art) shows relationship of resistivity and temperature for a transparent conductive film used as a temperature-sensing component.

FIG. 8 (Prior Art) shows relationship of voltage and current with respect to temperature for a diode-connected thin film transistor used as a temperature-sensing component.

### DETAILED DESCRIPTION OF THE INVENTION

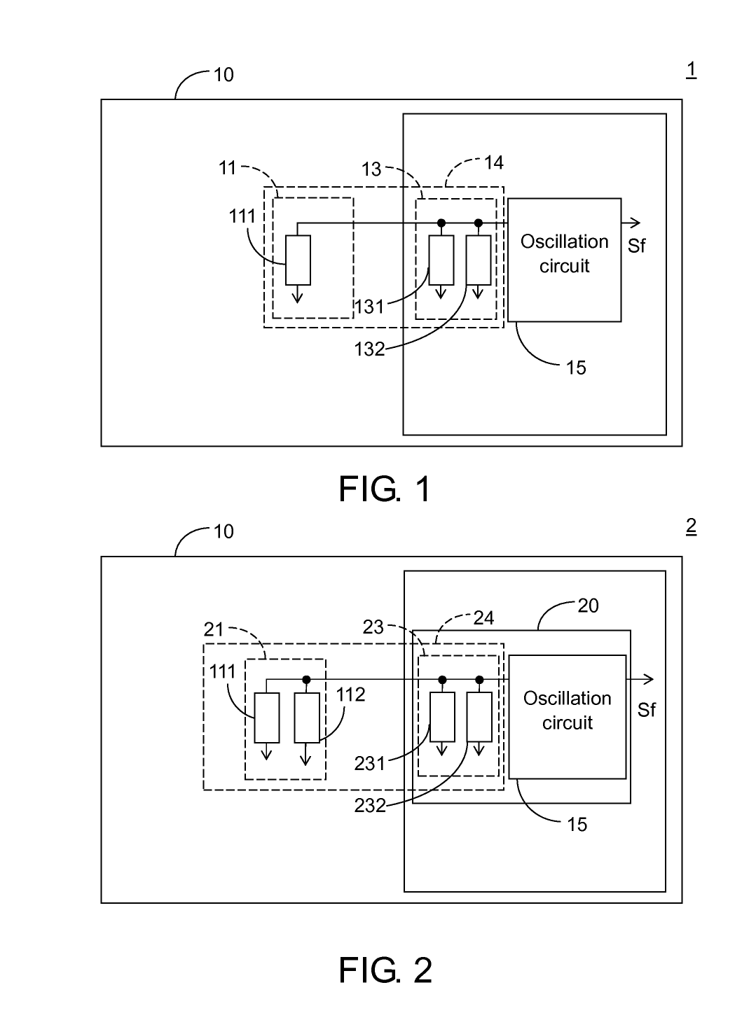

Embodiments of a display panel temperature sensing apparatus are provided below. FIG. 1 shows a block diagram of a display panel temperature sensing apparatus according to an embodiment. The display panel temperature sensing apparatus 1 includes a display panel 10, at least one temperature-sensing component 11, at least one passive device 13 and an oscillation circuit 15. The display panel 10 is realized by such as a liquid crystal display panel, an organic light emitting diode display panel or other types of display panel. The at least one temperature-sensing component 11, such as a temperature-sensing component 101, is disposed on the display panel 10. The temperature-sensing component 101 is realized by such as a circuit component with a temperature coefficient. The temperature-sensing component 101 may be formed by many identical circuit components or a combination of different circuit components such as temperature-sensing components 101 and 102 illustrated in FIG. 2. The temperature-sensing component 101 or a combination of temperature-sensing components may be realized by a circuit component additionally disposed on the display panel 10. Also, one, partial, or all of the at least one temperature-sensing component 11 may be realized by component(s) with temperature coefficients of the display panel 10 such as resistive component(s) or capacitive component(s). The at least one passive device 13 is coupled to the at least one temperature-sensing component 11 to form a resistance-capacitance (RC) structure 14. The oscillation circuit 15 is coupled to the RC structure 14, and an output terminal of the oscillation circuit 15 outputs a temperature-sensing signal Sf. The frequency of the temperature-sensing signal Sf is associated with the temperature sensed by the temperature-sensing component.

The RC structure 14 and the oscillation circuit 15 form an RC oscillation circuit, which generates a temperature-sensing signal Sf whose frequency f(T) is associated with the RC structure 14. The frequency f(T) denotes temperature data reflected by the temperature-sensing component. Display quality has much to do with temperature. If the temperature of the display panel can be obtained, the display parameter can then be compensated and adjusted to maintain the display quality according to the temperature. Therefore, the frequency f(T) of the temperature-sensing signal Sf can be used in other processing or control, and can be converted into a digital signal used in digital control and processing such as temperature compensation. Besides, the temperature-sensing signal Sf can be converted into a digital signal for the use in subsequent processing.

The display panel temperature sensing apparatus 10 of FIG. 1 may be implemented in different ways. For example, the RC structure 14 and the oscillation circuit 15 may form an RC oscillation circuit, wherein the RC oscillation circuit and the RC structure 14 may be implemented in different ways.

### First Embodiment

Referring to FIG. 2, a block diagram of a display panel temperature sensing apparatus 1 according to another embodiment is shown. The display panel temperature sensing apparatus 2 includes a display panel 10, at least one temperature-sensing component 21, at least one passive device 23 and an oscillation circuit 15. As indicated in FIG. 2, at least one passive device 23 of the display panel temperature sensing apparatus 2 includes at least one resistive component 231 (such as resistor R1) and at least one capacitive component 232 (such as capacitor C1). That is, in the present embodiment, at least one passive device 23 may also be realized by an RC structure. The at least one passive device 23 and the oscillation circuit 15 may form an RC oscillation circuit 20.

In the present embodiment, the at least one temperature-sensing component 21 may have a temperature-sensing component 111 and a temperature-sensing component 112, wherein each of the temperature-sensing component 111 and the temperature-sensing component 112 may be realized by a resistive component or a capacitive component.

In an example, the at least one temperature-sensing component 21 are all realized by resistive component, with resistance denoted by a variable R2(T) associated with temperature T. The RC oscillation circuit 20 generates a temperature-sensing signal Sf whose main frequency is associated with the values of variables R1 and C1. Then, the resistance-capacitance value of the entire RC structure 24 is changed according to the resistance R2(T) of the at least one temperature-sensing component 21 of the display panel 10 so as to change the main frequency. The frequency f(T) of the temperature-sensing signal Sf indicates the temperature data reflected by the temperature-sensing component and conducive to other application and processing such as these disclosed above. At temperature T, the resistance of the RC structure 24 can be expressed by: R′=1/(1/R1+1/R2(T)). Therefore, the frequency f(T) of the temperature-sensing signal Sf is associated with the temperature of the temperature-sensing component and can be expressed as:

f(T)=k*1/R′C,

f(T)=k*(1/R1+1/R2(T))/C,

where k is a coefficient, e.g., k=1/(2π).

In another example, the at least one temperature-sensing component 21 is all realized by a capacitive component whose capacitance is denoted by a variable C2(T) associated with temperature T. At temperature T, the capacitance of the RC structure 24 is expressed as: C′=C1+C2(T). Therefore, the frequency f(T) of the temperature-sensing signal Sf is associated with the temperature of the temperature-sensing component and is expressed as:

f(T)=k*1/RC′,

f(T)=k*1/R(C1+C2(T)).

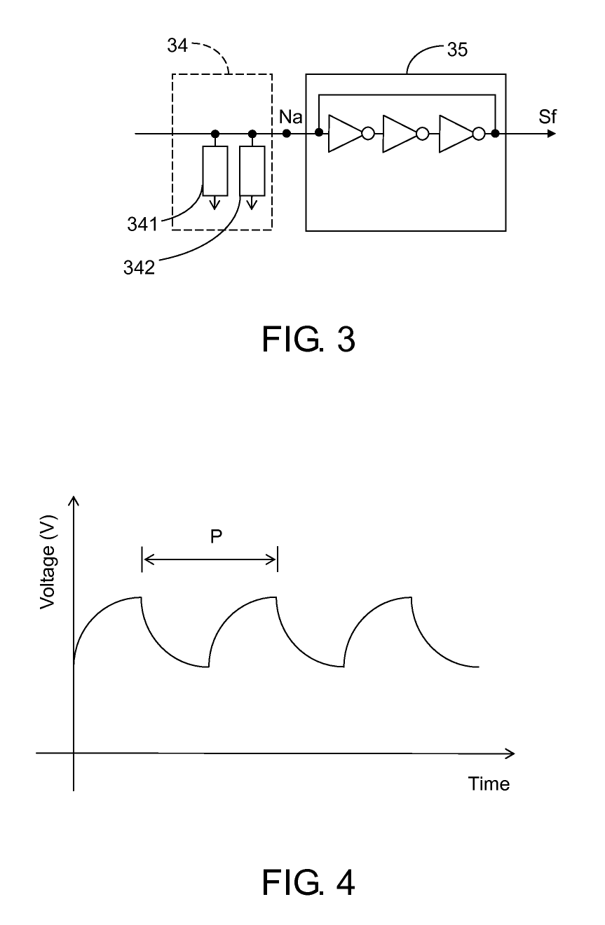

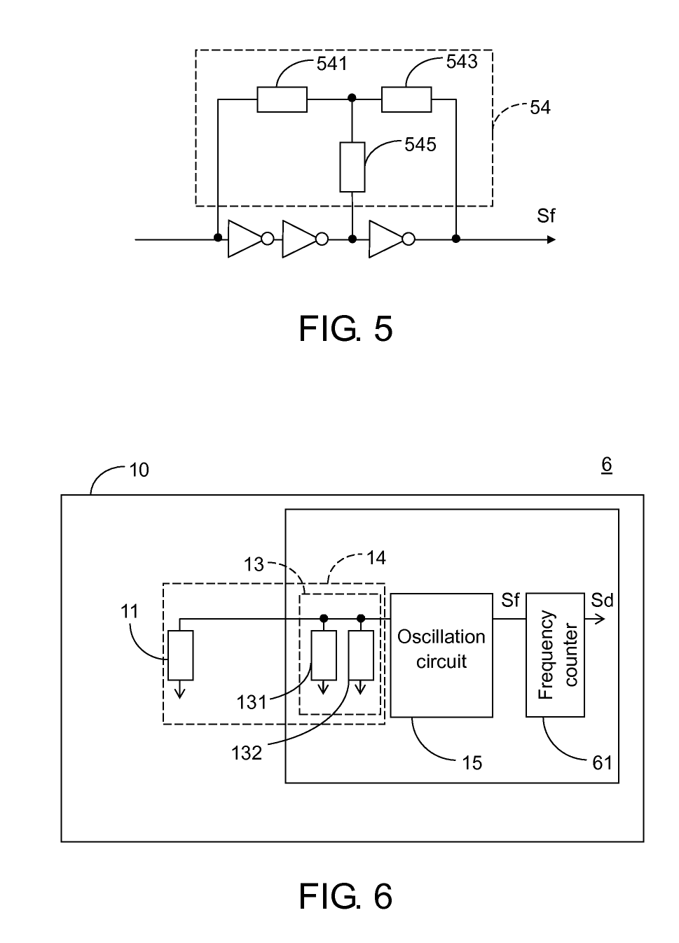

In addition, the oscillation circuit 15 of FIG. 1 and FIG. 2 may be realized by different circuits such as the oscillation circuit 35 illustrated in FIG. 3. The oscillation circuit 35 is an oscillator based on logic gates, including an odd number, such as three or more, of phase inverters connected in serial with feedback. In FIG. 3, the RC structure 34 indicates the overall RC structures 14 or 34 of FIG. 1 and FIG. 2. FIG. 4 shows a wave diagram of the output characteristics of an RC oscillation circuit of FIG. 3, wherein the wave shows the state of the voltage at a node Na varying with time. The period P in the wave diagram of FIG. 4 is associated with the RC value of the RC structure 3, and is expressed as: period P=k*RC. The oscillation circuit 15 may be connected to the RC structure 34 in different ways. For example, the RC structure 34 may be realized as an RC structure 54 indicated in FIG. 5, and the circuit components 541, 543 and 545 of the RC structure 54 are connected to each other in a T-type network and connected to inverters. The components 541 and 543 both are realized by such as resistive components, and the circuit component 545 is realized by such as a capacitive component. In some embodiments, any one of the circuit components 541, 543 and 545 may be viewed as a temperature-sensing component. Moreover, the RC structure may be realized by a π-type structure or other structure, and the oscillation circuit may be realized by other circuits such as an operation amplifier or a low-frequency oscillator such as a Wayne bridge.

### Second Embodiment

FIG. 6 shows a block diagram of a display panel temperature sensing apparatus 1 according to another embodiment. In comparison to the above embodiments, the display panel temperature sensing apparatus 6 further includes an additional circuit such as a frequency counter 61. The frequency counter 61 is coupled to an output terminal of the oscillation circuit 15 and outputs a temperature related digital signal Sd. The frequency counter 6 receives a temperature-sensing signal Sf, and then outputs the temperature related digital signal Sd whose frequency corresponds to the frequency f(T) of the temperature-sensing signal Sf. Corresponding temperature data of the temperature-sensing component can be obtained according to the temperature related digital signal Sd. The frequency counter 61 may be realized by such as a counter. Thus, the frequency f(T) of the temperature-sensing signal Sf may be directly used in other processing or control to facilitate digital control and processing, such as temperature compensation, to improve the display quality of a display panel.

Besides, an additional circuit of the second embodiment such as the frequency counter 61 may be replaced by a filter. The filter is coupled to the output terminal of the oscillation circuit 15 and outputs a temperature related analog signal, so that subsequent processing and application can be performed in an analog manner.

### Other Embodiments

One, partial, or all of at least one temperature-sensing component in each of the above embodiments can be exemplified by a resistive component with a temperature coefficient, which is included in the display panel 10. Table 1 shows respective relationship of resistivity and temperature coefficient of resistance for the metals that may be used in the components of a display panel structure.

TABLE 1

| | Temperature T | Resistivity | Temperature Coefficient |
|---|---|---|---|
| Material | (° C.) | (Ω · m) | of Resistance: a_{R} (° C.⁻¹) |
| Silver | 20 | 1.586 | 0.0038 (at 20° C.) |
| Copper | 20 | 1.678 | 0.00393 (at 20° C.) |
| Gold | 20 | 2.40 | 0.00324 (at 20° C.) |
| Aluminum | 20 | 2.6548 | 0.00429 (at 20° C.) |

In the display panel structure, since most electrical characteristics of the components are associated with temperature, most components can be used as a temperature-sensing component. For example, the metals illustrated in Table 1 are often used in a display panel structure and all have the characteristics of temperature-sensing resistance. These metals can be employed for forming the temperature-sensing components and the RC oscillation circuit of the above embodiment is used for outputting the temperature-sensing signal Sf which reflects the resistance difference so as to indicate the change in the temperature of the display panel 10. For example, the temperature-sensing component can be any metal wire resistor of the display panel 10.

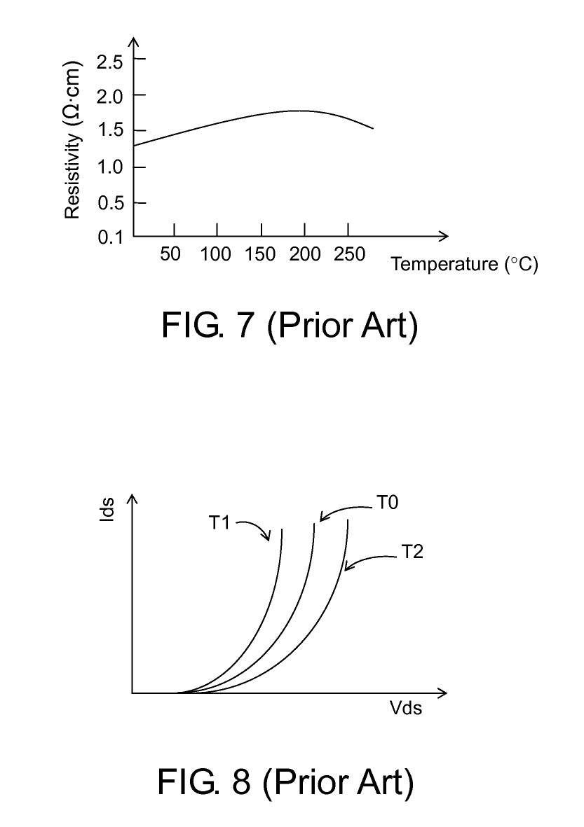

Other components with respective temperature coefficients, included in the display panel 10, can also be used as a resistive temperature-sensing component, such as a indium tin oxide (ITO) transparent conductive film resistor of the display panel 10. FIG. 7 shows a resistivity vs. temperature relationship for a transparent conductive film of a display panel 10. As indicated in FIG. 7, within some temperature range, such as 0 to 200° C., the relationship of resistivity and temperature is almost linear, so the transparent conductive film resistor can be used as a temperature-sensing component. The temperature value may also be obtained by way of interpolation or other methods.

The at least one thin film transistor (TFT) of the display panel 10 may also be used as a temperature-sensing component. For example, a thin film transistor is diode-connected such that a gate and a drain of the thin film transistor are connected to form a diode, with respect to a source of the thin film transistor. FIG. 8 indicates relationship of voltage and current with respect to temperature for a diode-connected thin film transistor used as a temperature-sensing component. As indicated in FIG. 8, as the temperature changes to T0, T1, and T2, the characteristics of the voltage Vds and the current Ids across the drain and the source of the diode-connected thin film transistor changes accordingly. Based on these characteristics, the diode-connected thin film transistor can be used as a temperature-sensing component.

In some embodiments, when the at least one temperature-sensing component 11 is one or more resistive components of the display panel 10, the at least one passive device 13 may be implemented by capacitive component(s) only, but the implementation of the RC structure 14 is not limited thereto.

Other components with temperature coefficients of the display panel 10 may also be used as a capacitive temperature-sensing component. For example, the temperature-sensing component is realized by a liquid crystal (LC) capacitance of the display panel 10. The temperature-sensing component realized by the at least one thin film transistor of the display panel 10 may also be used as a capacitive temperature-sensing component. For example, a thin film transistor is capacitor-connected such that a source and a drain of the thin film transistor are connected to form a capacitor, with respect to a gate of the thin film transistor. Also, the temperature-sensing component is realized by two conductors of the display panel 10, wherein the two conductors are parallel (or near parallel) to each other and are disposed on the display panel 10 and have capacitance characteristics.

In some embodiments, when the at least one temperature-sensing component 11 is used as a capacitive component of the display panel 10, the at least one passive device 13 may be implemented by resistive component(s) only, but the implementation of the RC structure 14 is not limited thereto.

In some other embodiments, the at least one temperature-sensing component 11 may be realized by a plurality of temperature-sensing components, and may be disposed at one or different positions of the display panel 10 for detecting the temperature at different parts of the display panel 10. The temperature-sensing components may be disposed inside or outside a pixel array or close to an edge of the pixel array. These temperature-sensing components are coupled to their corresponding at least one passive device, and output several corresponding temperature-sensing signals through the oscillation circuit. Each temperature-sensing signal indicates the temperature data at a corresponding position.

In other embodiments, the RC structure 14 of FIG. 1 may be implemented completely by a plurality of temperature-sensing components disposed on the display panel. The at least one passive device 13 as indicated in FIG. 1 may be dispensed with, and these temperature-sensing components may include at least one resistive temperature-sensing component and at least one capacitive temperature-sensing component, and may be coupled to form an RC structure. The resistive temperature-sensing component and the capacitive temperature-sensing component may be formed according to above embodiments or implemented in different positions.

In some embodiments, the display panel temperature sensing apparatus is realized by an integrated display module, and various temperature compensation modules may be integrated in the display panel temperature sensing apparatus to achieve an adjustment mechanism of temperature compensation for controlling and adjusting parameters related to the display panel and temperature. Thus, the display panel temperature sensing apparatus not only enables the improvement of the display quality of the display panel 10 but further reduces overall circuit area.

The display panel temperature sensing apparatus disclosed in above embodiments may be realized by a circuit having low complexity, and the functions of the circuit are extendable. In some embodiments, the display panel temperature sensing apparatus outputs a temperature-sensing signal Sf whose frequency f(T) may be converted into a digital signal for the sake of digital control and processing, such as temperature compensation, to maintain display quality according to the temperature. Also, subsequent processing may be performed in an analog manner. In some embodiments, the display panel temperature sensing apparatus is an integrated display module, not only integrating other circuits but also reducing overall circuit area.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel temperature sensing apparatus, comprising:
a display panel;
at least one temperature-sensing component disposed on the display panel;
at least one passive device coupled to the at least one temperature-sensing component to form a resistance-capacitance (RC) structure; and
an oscillation circuit coupled to the RC structure, wherein an output terminal of the oscillation circuit outputs a temperature-sensing signal.

2. The display panel temperature sensing apparatus according to claim 1, further comprising a frequency counter, wherein the frequency counter is coupled to the output terminal of the oscillation circuit and outputs a temperature related digital signal.

3. The display panel temperature sensing apparatus according to claim 1, further comprising a filter, wherein the filter is coupled to the output terminal of the oscillation circuit and outputs a temperature related analog signal.

4. The display panel temperature sensing apparatus according to claim 1, wherein one of the at least one temperature-sensing component is a circuit component with a temperature coefficient, which is included in the display panel.

5. The display panel temperature sensing apparatus according to claim 4, wherein one of the at least one temperature-sensing component is a resistive component with a temperature coefficient in the display panel.

6. The display panel temperature sensing apparatus according to claim 4, wherein one of the at least one temperature-sensing component is a metal wire resistor of the display panel.

7. The display panel temperature sensing apparatus according to claim 4, wherein one of the at least one temperature-sensing component is a transparent conductive film resistor of the display panel.

8. The display panel temperature sensing apparatus according to claim 4, wherein one of the at least one temperature-sensing component is a thin film transistor of the display panel, wherein the thin film transistor is diode-connected with a gate and a drain of the thin film transistor are connected.

9. The display panel temperature sensing apparatus according to claim 4, wherein each of the at least one passive device is a capacitive component.

10. The display panel temperature sensing apparatus according to claim 4, wherein the at least one passive device comprises at least one capacitive component and at least one resistive component.

11. The display panel temperature sensing apparatus according to claim 1, wherein one of the at least one temperature-sensing component is a capacitive component with a temperature coefficient, which is included in the display panel.

12. The display panel temperature sensing apparatus according to claim 11, wherein one of the at least one temperature-sensing component is a liquid crystal capacitor of the display panel.

13. The display panel temperature sensing apparatus according to claim 11, wherein one of the at least one temperature-sensing component is a thin film transistor of the display panel, and the thin film transistor is capacitor-connected such that a source and a drain of the thin film transistor are connected together to form a capacitor.

14. The display panel temperature sensing apparatus according to claim 11, wherein one of the at least one temperature-sensing component is two conductors of the display panel, and the two conductors are parallel to each other and have capacitor characteristics.

15. The display panel temperature sensing apparatus according to claim 11, wherein each of the at least one passive device is a resistive component.

16. The display panel temperature sensing apparatus according to claim 11, wherein the at least one passive device comprises at least one capacitive component and at least one resistive component.

17. The display panel temperature sensing apparatus according to claim 1, wherein the display panel is a liquid crystal display panel or an organic light emitting diode display panel.

18. A display panel temperature sensing apparatus, comprising:
a display panel;
a plurality of temperature-sensing components disposed on the display panel to form a resistance-capacitance (RC) structure, wherein the temperature-sensing components include at least one resistive temperature-sensing component and at least one capacitive temperature-sensing component; and
an oscillation circuit, wherein the oscillation circuit is coupled to the RC structure, and an output terminal of the oscillation circuit outputs a temperature-sensing signal.

19. The display panel temperature sensing apparatus according to claim 18, wherein the at least one resistive temperature-sensing component is a resistive component with a temperature coefficient, which is included in the display panel.

20. The display panel temperature sensing apparatus according to claim 18, wherein the at least one capacitive temperature-sensing component is a capacitive component with a temperature coefficient, which is included in the display panel.
